(19) United States
(12) Patent Application Publication
(10) Pub. No.: US 2008/0003945 A1
(43) Pub. Date: Jan. 3, 2008

(54) Interoperation of Terminals

(75) Inventor: Steven WENHAM, Cambridge (GB)

Correspondence Address: NOVAK DRUCE DELUCA & QUIGG, LLP, 1300 EYE STREET NW, SUITE 1000 WEST TOWER, WASHINGTON, DC, 20005, US

(73) Assignee: CAMBRIDGE SILICON RADIO LIMITED, Cambridge (GB)

(21) Appl. No.: 11/612,640

(22) Filed: Dec. 19, 2006

(30) Foreign Application Priority Data
Jan. 19, 2006 (GB) 0601095.3

(51) Int. Cl. H04B 7/00

(52) U.S. Cl. 455/41.2

(57) ABSTRACT

A communication system includes two or more command devices, each being capable of transmitting command signals over a communication interface; two or more response devices, each being capable of receiving such command signals over the communication interface and being capable of performing a non-communication function in response to such a command signal; at least one of the devices being remotely configurable so as to: if that device is a command device direct its command signals to a specific one of the response devices to the exclusion of one or more other of the response devices; or if that device is a response device accept signals from a specific one of the command devices to the exclusion of one or more other of the command devices.

### FIELD OF THE INVENTION AND BACKGROUND

This invention relates to configuring communication terminals to interoperate.

Devices in a Bluetooth communication system can communicate with each other by radio in accordance with the Bluetooth radio protocols. Each device has an individual device identity, which allows devices to identify one another, and allows each device to communicate with another specific device. In Bluetooth, devices can also be paired, by the exchange of security information between the devices so as to allow the devices to authenticate themselves to each other. Whether or not the devices are paired in a secure way, it can be advantageous for two devices to be configured to communicate specifically with each other. For example, a specific mobile phone may be configured to operate with a specific radio headset with the effect that when the phone is in operation it communicates with that particular headset to provide audio to a user via the headset. This can be achieved by each device having a unique identity in the system and the devices that are to communicate with it storing that identity and using it to connect to the device when required.

Devices may interoperate in this way for providing various functions to each other. For example, a notebook computer may be configured to interoperate with a specific mobile phone for communication functions and with a mouse for user input functions. This is achieved by a device storing the identities of the devices with which it is to interoperate in association with the functions for which they are paired. Then, when the device requires a particular function it can attempt to contact the appropriate counterpart device.

One objective of configuring devices in this way is to ensure that when there are several devices nearby, a device chooses to communicate with the right one. For example, in a crowded space several people might have mobile phones and headsets. Having each person configure their own devices to operate with each other prevents one person's phone providing audio to another person's headset.

By pairing the devices security can be enhanced since the chance of a rogue device successfully impersonating another device is reduced. Another objective of paring is to simplify security. Devices can store security data that allows them to satisfy the security requirements of the devices with which they are paired.

In order to configure two devices to interoperate each one must be set so as to store the other's identity. The identity of one device could be entered into the other device by a user. However, the identity is typically a long string, which the user could easily mis-type. Therefore, it is more normal for one device to be triggered by the user to perform a scan for other devices in the vicinity. When it has compiled a list of nearby devices it displays that list to a user, who selects from the list the one with which the device is to operate. Normally the user also selects a function for which the other device will be used. The device that the user is operating then stores the identity of the selected device for interoperation purposes. It may also communicate with the selected device to inform it that the configuration is being established and to pass it its own identity. The selected device then stores that identity for use when communication is required in the future.

Either of these procedures requires the user to be able to interact with at least one of the devices. That device must have some user input device, and preferably a display or other user output device, so that the user can carry out the steps described above. In the past this has not been a considerable hindrance. The cost of equipping a device with a transceiver for a complex system such as Bluetooth has meant that Bluetooth has been predominantly deployed in expensive products such as notebook computers, mobile phones, wireless headsets and computer mice. Such devices are typically equipped with a user interface as a matter of course; or if they are not the cost of equipping them with one is not considerable relative to the cost of equipping them with Bluetooth in the first place. For less expensive devices more simplistic communication protocols have been used, or devices have been set up at the factory before being shipped to users.

The cost of equipping a device with Bluetooth or a similar protocol is anticipated to fall. Bluetooth could then be economically used in a wide range of low-cost devices. Examples include light fittings, light switches, passive infra-red detectors, smoke detectors and tyre pressure detectors. Many of these devices would not naturally have user input means, and it would be uneconomical to incorporate them. In many cases it would be possible to configure these devices at the factory: for example a Bluetooth-equipped light fitting could be paired at the factory with a Bluetooth-equipped light switch and the two could be sold together as a kit. However, in most situations consumers would prefer to buy these devices individually, and not to have to replace both devices if one fails.

Alternatively, such devices could be configured to operate without specific configuration. This would be acceptable when the devices are out of range of other devices, but in many situations they would not function satisfactorily. For example, if a house were fitted with multiple Bluetooth-equipped light switches a Bluetooth-equipped light fitting that was in range of multiple switches would not know which of the switches to respond to.

There is therefore a need to improve the pairing mechanisms available to Bluetooth devices. Similar considerations apply where devices are to be configured for interoperation with each other under other communication systems than Bluetooth.

It is known that communication devices can be configured remotely. For example, mobile phones can be configured in some respects from the network, and personal computers and devices such as wireless LAN base stations can be configured over a wired or wireless network. Wireless LAN base stations can be configured for restricting their ability to communicate with other devices, for example by permitting only network adapters that have certain MAC addresses to establish a connection with them.

### SUMMARY OF THE INVENTION

According to one aspect of the present invention there is provided a communication system comprising: two or more command devices, each being capable of transmitting command signals over a communication interface; two or more response devices, each being capable of receiving such command signals over the communication interface and being capable of performing a non-communication function in response to such a command signal; at least one of the devices being remotely configurable so as to: if that device is a command device direct its command signals to a specific one of the response devices to the exclusion of one or more other of the response devices; or if that device is a response device accept command signals from a specific one of the command devices to the exclusion of one or more other of the command devices.

According to a second aspect of the present invention there is provided a response device for operation in a communication system comprising two or more command devices, each being capable of transmitting command signals over a communication interface and two or more response devices, each being capable of receiving such command signals over the communication interface and being capable of performing a non-communication function in response to such a command signal; the response device being remotely configurable so as to accept signals from a specific one of the command devices to the exclusion of one or more other of the command devices.

According to a third aspect of the present invention there is provided a command device for operation in a communication system comprising two or more command devices, each being capable of transmitting command signals over a communication interface and two or more response devices, each being capable of receiving such command signals over the communication interface and being capable of performing a non-communication function in response to such a command signal; the command device being remotely configurable to direct its command signals to a specific one of the response devices to the exclusion of one or more other of the response devices.

The said device may be a command device.

Each response device may have an identity that is unique in the system. The said device may then be configurable to store the identity of a or the specific one of the response devices. It may be arranged to automatically establish a communication link with the device whose identity is stored and to transmit command signals to that device over the communication link.

Each response device may have an identity that is unique in the system and the said device may be configurable to store the identity of the specific one of the response devices and is arranged to include the stored identity in command signals that it transmits.

The said device may be a response device.

Each command device may have an identity that is unique in the system. The said device may then be configurable to store the identity of the specific one of the command devices, and may be arranged to respond only to command signals that include an identity stored by it.

The said device may be configurable over the communication interface. The said device may be incapable of being so configured by means of any user interface that it comprises.

Each command device may comprise a sensor and be arranged to transmit a command signal in response to the sensing by the sensor of a change in state.

According to a fourth aspect of the present invention there is provided a computer program for execution by a computer that is capable of communicating over a communication interface for communicating with a response device or a command device as set out above so as to configure that device.

The or each command device may control one or more response devices. Each response device may be controlled by one or more response device. For example, if the control devices were in the form of user-operable light switches, and the response devices were light fittings, each light switch could control one or multiple light fittings and each light fitting could be controlled by one or by multiple light switches.

### BRIEF DESCRIPTION OF THE DRAWINGS

The present invention will now be described by way of example with reference to the accompanying drawings, in which:

FIG. 1 shows components of a communication system installed in a house; and

FIG. 2 shows some of those components schematically in more detail.

### DETAILED DESCRIPTION OF PREFERRED EMBODIMENTS

In an example of the present invention devices that are to be configured to communicate with specific other devices are configured by default so that they can at least initially communicate with a third device. That third device can then be used to configure the other devices to operate selectively with each other. This mechanism avoids the need for the devices that are to be configured to have any local user interface since the user can use the user interface of the third device to carry out the configuration.

The present invention will be described in relation to the example of Bluetooth-equipped light switches and light fittings. It will be appreciated that this is merely an illustrative example of a situation in which the present invention can be used.

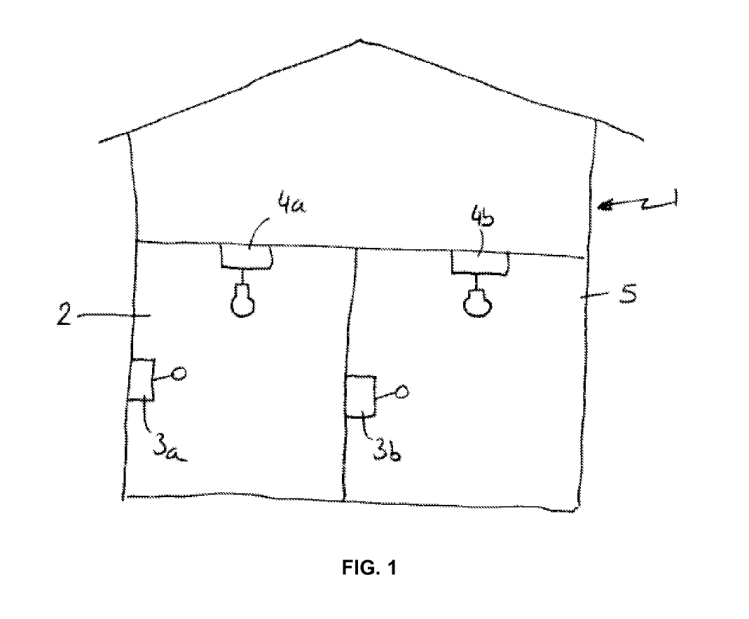

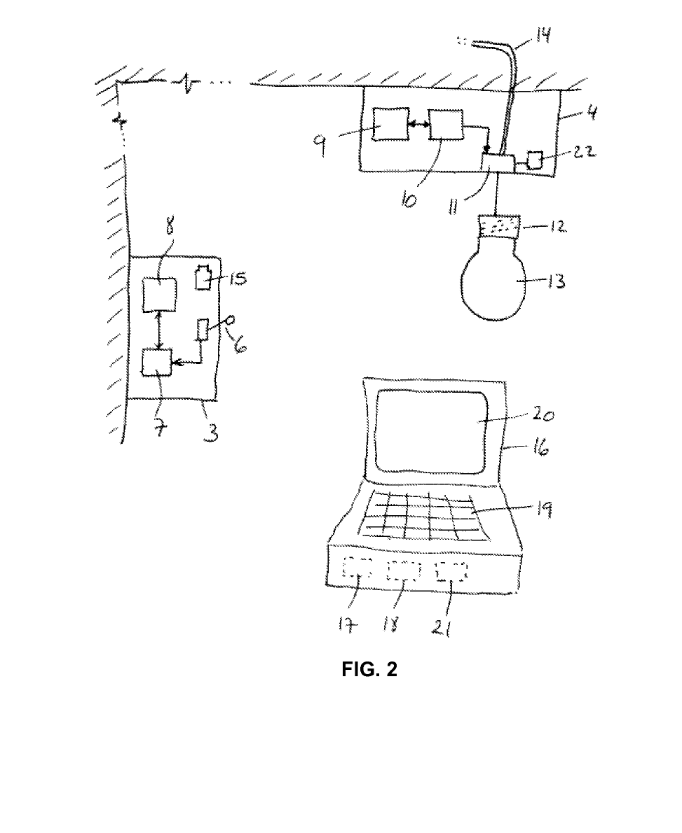

FIGS. 1 and 2 illustrate a communication system in use in a house 1. Referring to FIG. 1, in room 2 a light switch device 3a and a light fitting 4a are installed. In room 5 a light switch device 3b and a light fitting 4b are installed. Example devices of FIG. 1 are shown in more detail in FIG. 2.

Each light switch device 3 includes a user-actuable control switch 6, a controller 7 and a Bluetooth transceiver 8. Each controller 7 is configured to cause the respective Bluetooth transceiver to signal to a paired light fitting when the respective switch 6 is operated.

Each light fitting 4 includes a Bluetooth transceiver 9, a controller 10, switchgear 11 and a fitting 12 whereby a bulb 13 can be attached to the fitting. Each controller 10 is arranged so as to signal the switchgear of its light fitting when it receives a signal from a light switch with which it has been configured to operate so as to cause the switchgear to connect or disconnect the light bulb from an input voltage.

As is conventional, the light fittings are wired to the mains electrical supply 14 of the house. However, the light switches are not: they are simply attached to the walls of the house without being attached to the mains supply. It will be appreciated that this type of arrangement is advantageous in that it reduces the amount of work needed to install lighting circuits and reduces the disruption to decoration that is normally involved in installing the cabling for lighting circuits. The controllers and transceivers of the light fittings are powered from the mains via a voltage converter 22. Batteries 15 are fitted into the light switches to power their components.

As will be described in more detail below, the devices 3 and 4 are arranged so that their pairing can be configured remotely by means of a portable computer 16. The portable computer has a central processor 17, a program store 18 such as a hard disk, a keyboard 19, a display 20 and a Bluetooth transceiver 21. The computer is loaded with a program that allows it to configure the devices 3 and 4 in the manner to be described.

The controller 7 of each light switch device 3 is configured to interface between its switch 6 and its Bluetooth transceiver 8. The controller supervises the configuration of the Bluetooth transceiver for communicating with other devices. In particular, the Bluetooth transceiver is arranged to be capable of being set up to communicate with a specific counterpart device under the control of the controller 7. In its default, factory-supplied state the Bluetooth transceiver 8 is not configured to interoperate with any specific device. The controller is configured to permit connection to the device 3 for configuration purposes by any other suitable device. The connection for configuration purposes may present as a pre-defined type of connection, for instance a network connection or a serial connection, for compatibility with other devices. When such an other device (for example computer 16) is in communication with the light switch device 3 the traffic data that it sends to the light switch device is passed through to the controller so that it can control configuration of the light switch device.

The controller of each light fitting device is arranged to interface between its switchgear and its transceiver. Otherwise, the controller and the transceiver of the light fitting device are arranged in a similar way to those of the light switch device. In particular, the transceiver 9 can be configured by the controller 10 to interoperate with a specific device.

Initially neither the light fitting devices nor the light switch devices are configured to operate with any other specific devices. As a result, the light fitting cannot at that point be controlled by the light switch devices. Configuration of the system is performed in the following way. The user operates the software running on computer 16 to scan for nearby Bluetooth devices. This reveals the light switch devices 3a, 3b and the light fitting devices 4a, 4b, which are listed in a view on the computer's screen. The computer acquires the identity (e.g. a system address) of each device. The devices present themselves as being of a specific type so that the software that is running on the computer can distinguish the types of devices from each other. The user operates the user interface of the computer to select one of the light switch devices and one of the light fitting devices and then to select a “join” option using the software running on the computer. On selection of the join option the software running on the computer communicates via the computer's Bluetooth transceiver with each of the devices that are to be joined. It transmits to each device traffic data which will be communicated by each device's Bluetooth transceiver 8,9 to its controller 7,10. The traffic data comprises a JOIN command which includes the identity of the device with which the recipient device is to be paired. In response to the JOIN command the controller of the recipient device configures its Bluetooth transceiver for communicating with the device whose identity was included in the command. The recipient device then returns a message to the computer indicating whether the pairing configuration has been successful. Once both the selected devices have been configured in this way the computer indicates to the user that the pairing operation has been executed correctly.

The effect of this configuration for the transceiver of a light switch is that it is configured to transmit commands by Bluetooth to the light fitting device that identified in the JOIN command. The manner in which it transmits commands specifically to that device will depend on the protocol that is in use, but in the case of Bluetooth it could do so by establishing a communication link with that device and then transmitting the command to it. The effect of this configuration for the transceiver of a light fitting is that it is configured to accept commands by Bluetooth from the light switch device that is identified in the JOIN command. Thus the desired light fitting will operate under the control of the desired light switch. However, the light fitting will still not be influenced by signals transmitted by other light switches or other devices altogether, since it is not joined with them.

It would be possible for only one of the devices to be configured. If the light switches were to transmit their commands only to specific light fittings then the light fittings need not filter the commands they receive. Alternatively, the light switches could broadcast their commands and the light fittings could respond only to commands sent from the appropriate switch. Devices could be configured to operate with more than one counterpart. Switches could be configurable to transmit commands to multiple light fittings. Light fittings could be configured to respond to multiple switches. All these principles can be readily extended to devices other than light switches and fittings.

Devices can be un-joined in an analogous way, using an UNJOIN command.

The devices could also be paired, by the exchange of security information that can later be used to authenticate one to the other. Pairing of the devices can also be commanded by the computer 16.

An alternative arrangement is for the controllers of each device to be arranged so as to be responsive to a request from a counterpart device to set up a relationship with it so that they can interoperate. In this embodiment each device is arranged to respond to the JOIN command by communicating with the device identified in the command so as to attempt to join with it. Then when the user issues a JOIN command the recipient device attempts to join with the identified device and the devices exchange information on each others' identities and store that information so as to configure the devices in establishment of the relationship.

Thus the devices can be paired without the need for them to be fitted with a user interface. Furthermore, the devices can be paired without the user having to be physically adjacent to either of the devices. This is advantageous if the devices are not readily accessible or if they are spread over a wide area. In the present example, a user could configure the switches and light fittings of an entire house from one location, provided they were all in range of the device he was using for configuration.

The configuration device could be a dedicated device, or as described above it could be a suitably programmed general purpose computer. It could conveniently be a portable battery-powered device such as a laptop computer or a PDA.

The list of available devices could be generated as a result of a network scan performed by the transceiver of the configuration device 16. Alternatively, it could be performed by any one or more of the devices that are to be configured, which could report to the configuration device on what devices they can communicate with. The communication device could then list those devices to a user. The latter method may be advantageous when not all of the devices are in range of the configuration device.

The devices that are configured could take any suitable form. They could, for example, be DVD players and speakers that are to be configured to operate with each other, or passive infra-red detectors and an alarm system controller that are to be configured to operate with each other, or they could be road signs and traffic detection devices embedded in a road that are to be configured to operate with each other. The invention is most advantageous if the devices are relatively inaccessible or do not have any user input device (or as in the case of the light switch described above, the device is configured so that any user input device that it does have is not capable of influencing pairing). In response to a control signal that it is configured to respond to, the device that responds to control signals (e.g. the light fitting) preferably performs a function that is not related to a telecommunication system. For example, a wireless speaker or an alarm bell box could emits sound on receipt of the signal. The device that responds to control signals could itself control a further device. The device that responds to control signals could communicate bidirectionally with its controller, and so report its status to the controller. For example, the responsive device could be a light switch that could be controlled by a wireless transceiver attached to a personal computer that is programmed to cause the transceiver to transmit signals to control the light switch and thereby turn a light connected to the switch on and off. The light switch could report its status back to the PC via the transceiver. In another example, the responsive device could be a speaker of a surround sound system. The system could cause each of its speakers to emit sound in turn so that a user can ensure the correct one for each audio channel has been located.

Instead of the controller communicating with the configurable devices over the same form of interface as is to be configured for those devices to communicate with each other another form of interface could be used. Examples are a wired interface to a suitable connector on the configurable devices, or the use of near-field communication. However, it is preferred that the same interface is used, since that avoids the need for the configurable devices to have multiple transmitters and/or receivers. It is also preferred that the connection used for configuration and, independently, the connection used for communication between the devices is a wireless connection; for instance a radio connection,

It is preferred that the configurable devices are capable of bidirectional communication with each other, since more sophisticated communication protocols can then be used between them. However, the device that receives commands from the other need not have a transmitter. And the device that issues commands to the other need not have a receiver operable on the interface that is used between the configurable devices unless that interface is also used for configuring that device.

The transceivers and the controllers could be integrated, for example on a single integrated circuit.

The devices could communicate by a means other than Bluetooth, for example a wireless LAN protocol such as 802.11 or a UWB (ultra-wideband) protocol. The system described above is still applicable for configuring the devices to communicate exclusively with one or more other devices.

The PAIR command could include additional attributes. For example, it could include configuration and/or security information such as a security code or PIN that may be required for connecting with the other device. It could include other configuration data related to the link or control of the device: for instance it could include data identifying which switch on a multi-gang switch unit is to control which light fitting.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A communication system comprising:
at least two command devices, each being capable of transmitting command signals over a communication interface;
at least two response devices, each being capable of receiving such command signals over the communication interface and being capable of performing a non-communication function in response to such a command signal; at least one of the command and response devices being remotely configurable so as to:
if that device is a command device direct its command signals to a specific one of the response devices to the exclusion of one or more other of the response devices; or
if that device is a response device accept command signals from a specific one of the command devices to the exclusion of one or more other of the command devices.

2. A communication system as claimed in claim 1, wherein the configurable device is a command device.

3. A communication system as claimed in claim 2, wherein each response device has an identity that is unique in the system and the said device is configurable to store the identity of the specific one of the response devices and is arranged to automatically establish a communication link with the device whose identity is stored and to transmit command signals to that device over the communication link.

4. A communication system as claimed in claim 2, wherein each response device has an identity that is unique in the system and the said device is configurable to store the identity of the specific one of the response devices and is arranged to include the stored identity in command signals that it transmits.

5. A communication system as claimed in claim 1, wherein the configurable device is a response device.

6. A communication system as claimed in claim 5, wherein each command device has an identity that is unique in the system and the said device is configurable to store the identity of the specific one of the command devices is arranged to respond only to command signals that include an identity stored by it.

7. A communication system as claimed in claim 1, wherein the configurable device is configurable over the communication interface.

8. A communication system as claimed in claim 1, wherein the configurable device is incapable of being so configured by means of any user interface that it comprises.

9. A communication system as claimed in claim 1, wherein each command device comprises a sensor and is arranged to transmit a command signal in response to the sensing by the sensor of a change in state.

10. A response device for operation in a communication system comprising at least two command devices, each being capable of transmitting command signals over a communication interface and at least two response devices, each being capable of receiving such command signals over the communication interface and being capable of performing a non-communication function in response to such a command signal;
a response device being remotely configurable so as to accept signals from a specific one of the command devices to the exclusion of one or more other of the command devices.

11. A response device as claimed in claim 10, wherein a response device is remotely configurable so as to accept signals from two or more of the command devices to the exclusion of one or more other of the command devices.

12. A command device for operation in a communication system comprising at least two command devices, each being capable of transmitting command signals over a communication interface and at least two response devices, each being capable of receiving such command signals over the communication interface and being capable of performing a non-communication function in response to such a command signal;
a command device being remotely configurable to direct its command signals to a specific one of the response devices to the exclusion of one or more other of the response devices.

13. A command device as claimed in claim 12, wherein a command device is remotely configurable to direct its command signals to two or more specific ones of the response devices to the exclusion of one or more other of the response devices.

14. A computer program for execution by a computer that is capable of communicating over a communication interface for communicating with a response device as claimed in claim 10 so as to configure that device.

15. A computer program for execution by a computer that is capable of communicating over a communication interface for communicating with a response device as claimed in claim 11 so as to configure that device.

16. A computer program for execution by a computer that is capable of communicating over a communication interface for communicating with a command device as claimed in claim 12 so as to configure that device.

17. A computer program for execution by a computer that is capable of communicating over a communication interface for communicating with a command device as claimed in claim 13 so as to configure that device.
